(19) United States
(12) Patent Application Publication
(10) Pub. No.: US 2004/0032167 A1
(43) Pub. Date: Feb. 19, 2004

(54) Power control center for outdoor use to transfer household voltage and low voltage to remote locations

(76) Inventors: Miguel Angel Larios, Castaic, CA (US); Brett Franklin Thompson, Westchester, CA (US)

Correspondence Address: CHRISTIE, PARKER & HALE, LLP, P.O. BOX 7068, PASADENA, CA, 91109-7068, US

(21) Appl. No.: 10/624,956

(22) Filed: Jul. 21, 2003

Related U.S. Application Data
(60) Provisional application No. 60/400,668, filed on Aug. 5, 2002.

(51) Int. Cl. H02J 1/00

(52) U.S. Cl. 307/31

(57) ABSTRACT

A power control center with an enclosure has multiple line voltage receptacles and a low voltage receptacle mounted thereon. Voltage supplied by the low voltage receptacle is lower than the voltage supplied by the line voltage receptacle. Voltage supplied by the line voltage receptacles corresponds to voltage remotely supplied to the power control center. One of the line voltage receptacles is controlled by a digital timer and the low voltage receptacle is controlled by another digital timer. Both digital timers are mounted on the enclosure. A cover is connected to the enclosure to encase the line, low voltage receptacles and digital timers.

### CROSS-REFERENCE TO RELATED APPLICATION(S)

This application claims benefit of U.S. Provisional Application No. 60/400,668, filed Aug. 5, 2002, the disclosure of which is hereby incorporated by reference as if set forth in full herein.

### BACKGROUND OF THE INVENTION

The invention generally relates to power distribution and more particularly to remotely distributing line and low voltages in outdoor environments.

Electrical outlets scattered throughout a residential or commercial property provide access to electrical power. In outdoor environments, however, access to the electrical outlets and thus power is often limited. Typical electrical outlets and other power devices are also sometimes unsuitable for harsh outdoor conditions. For example, exposure to various weather effects, humidity, varying temperatures and ultra-violet rays can cause deterioration to the outlet or power device rendering it unusable. As such, long term use of the outlet or power device is not practical.

In addition to limited power access, power distribution is restricted or unavailable in terms of functionality and flexibility. For example, the flexibility and ability to power devices having different voltage requirements, e.g., outdoor lights versus water pumps, are sometimes desirable but are often unavailable. Additionally, the functionally to control these devices without much or any user interaction is also not available. A central protected unit capable of providing the above added functionally and flexibility to remotely distribute power is also not provided.

### SUMMARY OF THE INVENTION

The invention provides a self contained central unit having controllable multiple receptacles capable of supplying differing voltage, such that power is distributed from a remote location.

In one aspect of the invention, a power control center apparatus configured to remotely distribute power is provided. The power control center apparatus has an enclosure. A first line voltage receptacle, a second line voltage receptacle and a low voltage receptacle are mounted on the enclosure. A first timer is coupled to the first line voltage receptacle and is configured to control the output of the voltage supplied from the first line voltage. A second timer is coupled to the low voltage receptacle and is configured to control the output of the voltage supplied from the low voltage receptacle.

In another aspect of the invention, a method of remotely distributing power using a power control center apparatus is provided. The method comprises receiving voltage from an input voltage line and supplying a first line voltage and a second line voltage from the received voltage. A low voltage having a voltage level less than the first line voltage is also supplied. Furthermore, the supplying of the first line voltage and the supplying of the low voltage are regulated.

In yet another aspect of the invention, a power control center apparatus configured to remotely distribute power is provided with an enclosure having a plurality of sides, a top and a bottom. A first line voltage receptacle, a second line voltage receptacle and a low voltage receptacle are mounted on one of the plurality of sides. An input voltage line is also built into the enclosure and has one end extending out from the bottom of the enclosure. A first timer has a display and actuators and is configured to control the output of the voltage supplied from the first line voltage. The supplied voltage corresponds to voltage supplied by the input voltage line and the display and actuators are mounted on the one of the plurality of sides and are proximate to the first line voltage receptacle. A second timer has a display and actuators and is configured to control the output of the voltage supplied from the low voltage receptacle. The supplied voltage is less than the voltage supplied by the input voltage line and the display and actuators are mounted on the one of the plurality of sides and are proximate the low voltage receptacle. A movable cover arranged to extend over the first line voltage receptacle, the second line voltage receptacle, the low voltage receptacle, the first timer and the second timer is attached to two sides of the plurality of sides with each of the two sides being adjacent to the one of the plurality of sides.

Many of the attendant features of this invention will be more readily appreciated as the same becomes better understood by reference to the following detailed description considered in connection with the accompanying drawings.

### BRIEF DESCRIPTION OF THE DRAWINGS

FIG. 1 is a front view of one embodiment of a power control center;

FIG. 2 is a side view of one embodiment of a power control center; and

FIG. 3 is a semi-schematic diagram of one embodiment of a power control center.

### DETAILED DESCRIPTION OF THE INVENTION

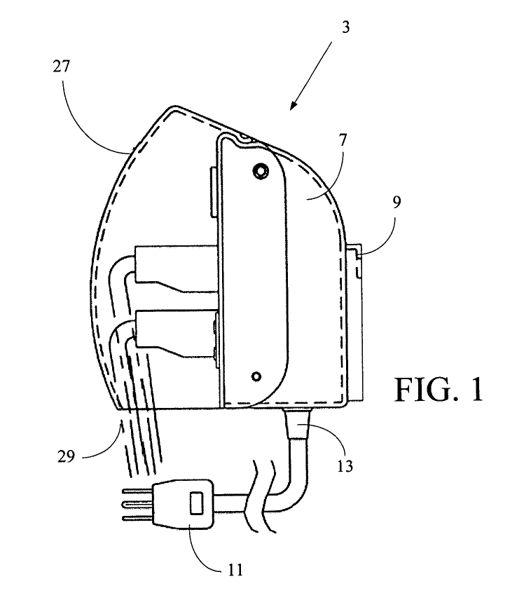

In FIG. 1, a power control center 3 includes an enclosure 7. The enclosure 7 is rectangular in shape and is no greater than about three inches wide or deep. The height of the enclosure is about five and one half inches high and about eight and one half inches long. In various other embodiments, the enclosure 7 varies in size and shapes. The enclosure 7 is also made of impact and weather resistant, including water and ultra-violent protection, materials, such as a poly-carbonate. Mounting tabs 9 located on a portion of the enclosure 7 permits mounting of the enclosure on a wall, fence or other similar types of supporting structures.

The enclosure 7 is self contained, but is also coupled to an input voltage line 11. The input voltage line 11 is about 50 feet long, provides a household voltage of about 110/115 VAC and is built or molded into the enclosure 7. The input voltage line 11 enters/exits through a portion of the enclosure via a strain relief connector 13. Other connectors, such as a PVC boot, may also be utilized to reduce weather effects on the coupling of the input voltage line and the enclosure 7. The end of the input voltage line not coupled to the enclosure is connected to a remotely located power source (not shown) via, for example, a ground fault circuit interrupt outlet. The power source, in one embodiment, is protected from or otherwise suited for outdoor use. The other end of the input voltage line coupled to the enclosure 7 includes wires.

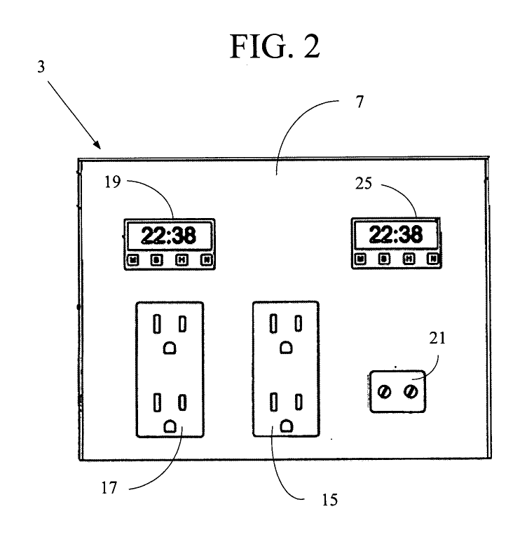

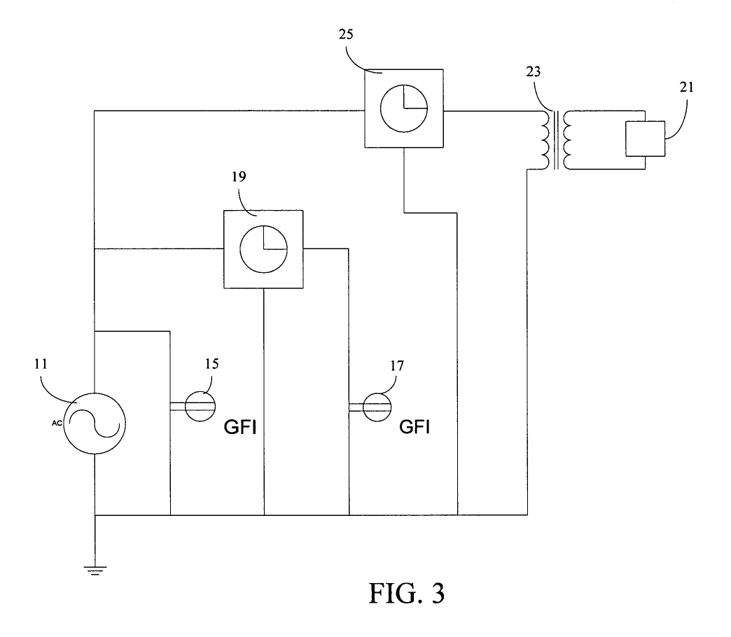

Referring now to FIGS. 2-3, the wires within the enclosure 7 connects the input voltage line 11 to two line voltage receptacles 15 and 17. The line voltage receptacles 15 and 17 are mounted on one side of the enclosure 7. Each line voltage receptacle includes a hot, neutral and ground slot connected to respective wires from the input voltage line 11. The line voltage receptacles 15 and 17 also include ground fault interrupt circuits to ensure that current flowing from the hot slot to the neutral slot is balanced. With the wires from the input voltage line 11 being directly coupled to the line voltage receptacle 15, 110/115 VAC and a respective current is continuously supplied to the line voltage receptacle 15. As such, any device, such as motors, pumps, lights and others, plugged into the line voltage receptacle 15 is continuously supplied power.

Devices, such as motors, pumps, light and others, may also be plugged into the line voltage receptacle 17. The line voltage receptacle may also continuously supply power, but, in one embodiment is configured to supply power at predetermined times. In this embodiment, wires from the input voltage line 11 to the line voltage receptacle 17 is interrupted or first coupled to a line voltage timer 19 which is coupled to the line voltage receptacle 17.

The line voltage timer 19 regulates or controls the output of the voltage and/or current supplied from the input voltage line 11 to the line voltage receptacle 17. The line voltage timer 19 is mounted on the side of the enclosure 7 proximate the line voltage receptacle 17. The line voltage timer may be digital, analog or mechanical. For example, the line voltage timer may include a processor that controls a triac or transistor to prevent or allow the supply of voltage and/or current from the input voltage line 11 to the line voltage receptacle 17. The processor may be programmed via a user interface, e.g., a display and associated buttons, to control the output of the supply of voltage and/or current. The user interface is visibly mounted on the enclosure 7, proximate the line voltage receptacle 17, and is coupled to the line voltage timer 19. As such, the timer 19 may be programmed to turn on/off connected devices at specific times and for a particular duration.

A low voltage receptacle 21 is also mounted on the enclosure 7. The low voltage receptacle 21 includes two terminals, a positive and a negative terminal. Low voltage devices, such as underwater lights, may be wired to the terminals. In one embodiment, the terminals are screws, levers, or knobs mounted on the enclosure 7. Wires within the enclosure 7 connects the input voltage line 11 to a transformer 23. The transformer 23 steps down or lowers the voltage from the input voltage line. As such, the transformer supplies an AC voltage substantially lower than the AC voltage from the input voltage line. For example, the transformer, receiving the 110/115 VAC from the input voltage line 11, supplies a 12 VAC to the low voltage receptacle 21.

The transformer 23 is an electronic transformer including a copper ground shield separating the primary and secondary windings of the transformer. The copper ground shield is coupled to the core or ground of the transformer and thus shunts stray or unintended current and/or voltage from the windings directly to ground. Therefore, if there is a fault in the transformer 23, the device wired to the transformer is protected from the unintended current and/or voltage.

A device wired to the low voltage receptacle 21 may be continuously supplied power, but, in one embodiment, the low voltage receptacle is configured to supply power at predetermined times. In this embodiment, the voltage from the transformer 23 to the low voltage receptacle 21 is directed or first coupled to a low voltage timer 25. The low voltage timer 25 is similar to the line voltage timer 19 but is coupled to the low voltage receptacle 21 and regulates or controls the output of the voltage and/or current supplied from the transformer 23 to the low voltage receptacle 21.

The low voltage timer 25 is mounted on the side of the enclosure 7 proximate the low voltage receptacle 21. The timer also includes a user interface that is visibly mounted on the enclosure 7, proximate the low voltage receptacle 21, and is coupled to the low voltage timer 25. As such, the timer 25 may be programmed to turn on/off devices connected to the low voltage receptacle at specific times and days and for a particular duration.

In another embodiment, wires from the input voltage line is interrupted or first coupled to the line voltage timer 25 which is coupled to the transformer 23. As such, in a similar manner as described above, the low voltage timer 25 is able to control the output of the voltage and/or current supplied from the input voltage line 11 to the transformer 23.

Referring now back to FIG. 1, a movable cover 27 is also coupled to the enclosure 7. The movable cover encloses or encases a portion of the enclosure 7. In particular, the movable cover 27 encases the two line voltage receptacles 11, 13, the line voltage timer 19, the low voltage receptacle 21 and the low voltage timer 25, along with any associated user interface coupled to the line voltage timer 19 and the low voltage timer 25. Cords or wires 29 coupled to the respective line and low voltage receptacles are also covered by the movable cover. The movable cover, however, is not completely enclosed or provides an opening through which the connections, e.g., cords or wires, may extend to associated devices. The cover is made of plastic or another material that is water proof and/or weather resistant. Thus, the portions of the cords and/or wires and their connection to the respective receptacles are protected from water and/or weather.

The movable cover 27 pivots on posts connected to two sides of the enclosure 7. The movable cover, as such, may be moved to provide easy access to the line and low voltage receptacles 11, 13 and 21 to connect devices to each of the receptacles. Additionally, by moving the movable cover, the line voltage timer 19, low voltage timer 25 and any associated user interface is easily accessed. The movable cover 27 is also transparent or slightly smoked to visually allow inspection of the timers and the receptacles.

Referring now to FIGS. 1-3, the power control center 3 remotely distributes power to various types of devices with the added flexibility to control the on/off times of these devices. For example, the power control center 3, operating in an outdoor garden with a pond, may have a pump operating with a filter for the pond connected to the line voltage receptacle 15. As such, the pump is continuously powered to keep the pond water clean. A water pump for a waterfall flowing into the pond may also be connected to the line voltage receptacle 17 to turn on/off at times specified via the digital timer 19. For example, the waterfall may be turned off on weekdays and turned on during the weekend. Submersible lights in the pond, expecting or rated to only receive a low AC voltage, may be coupled to the low voltage receptacle 21. The lights may also be programmed to turn on/off at times specified by the digital timer 25, e.g., on at night and off during the day.

The power control center 3 receiving power via an input voltage line 11 from a power source (not shown) at a remote location, thus remotely distributes power to various devices as described above. Therefore, the power control center distally increases the distribution of power. The power control center also being water, ultra-violent, and weather protected reduces the potential problems to the devices and the connections to the devices from the power control center. Furthermore, the power control center does not require the power source to be similarly protected, e.g., water resistant. Likewise, the power control center may also be temporarily or permanently situated in an outdoor environment without any special power feed. The power control center 3, as one unit, also numerically and operationally increases the connection to various devices via a single input voltage line 11. For example, five different devices may be powered by the power control center and one of the devices is supplied a different but expected voltage level, i.e., a voltage lower than the voltage from the line voltage input.

Accordingly, the invention provides methods and systems to remotely distribute power from a protected central unit. Although this invention has been described in certain specific embodiments, many additional modifications and variations would be apparent to those skilled in the art. It is therefore to be understood that this invention may be practiced otherwise than is specifically described. Thus, the present embodiments of the invention should be considered in all respects as illustrative and not restricted, the scope of the invention to be indicated by the appended claims rather than the foregoing description.

What is claimed is:

1. A power control center apparatus configured to remotely distribute power, the apparatus comprising:
an enclosure;
a first line voltage receptacle mounted on the enclosure;
a second line voltage receptacle mounted on the enclosure;
a low voltage receptacle mounted on the enclosure;
a first timer coupled to the first line voltage receptacle and configured to control output of voltage supplied from the first line voltage; and
a second timer coupled to the low voltage receptacle and configured to control output of voltage supplied from the low voltage receptacle.

2. The apparatus of claim 1 wherein the enclosure is mountable.

3. The apparatus of claim 1 further comprising an input voltage line coupled to the enclosure and configured to continuously supply voltage to the first line voltage.

4. The apparatus of claim 1 further comprising a transformer coupled to the input voltage line.

5. The apparatus of claim 4 wherein the transformer has a primary winding, a secondary winding, and a copper shield separating the primary winding from the secondary winding.

6. The apparatus of claim 4 wherein the transformer is a electronic transformer.

7. The apparatus of claim 4 wherein the transformer is configured to prevent unexpected voltage from the primary winding being transferred to the secondary winding.

8. The apparatus of claim 7 further comprising a power source remotely located from the enclosure and coupled to the input voltage line.

9. The apparatus of claim 1 wherein the second timer is programmable to allow supply of voltage from the low voltage receptacle at specified times.

10. The apparatus of claim 1 wherein the first timer is programmable to allow supply of voltage from the first line voltage receptacle at specified times.

11. The apparatus of claim 1 further comprising a cover curved and extending over the first line voltage receptacle, second line voltage receptacle, low voltage receptacle, the first timer, and the second timer.

12. The apparatus of claim 11 wherein the first line voltage receptacle is configured to receive a first voltage connection, the second line voltage receptacle is configured to receive a second voltage connection, and the first and second voltage connections are partially encased by the cover.

13. The apparatus of claim 12 wherein the cover defines an inside portion encasing a portion of the enclosure and being proximate the first line voltage receptacle, the second line voltage receptacle, the low voltage receptacle, the first timer, and the second timer, and wherein the first and second voltage connections extend away from the enclosure and the inside portion of the cover.

14. The apparatus of claim 11 wherein the cover is movable to assist in accessing one of the first line voltage receptacle, the second line voltage receptacle, the low voltage receptacle, the first timer, and the second timer.

15. The apparatus of claim 11 wherein the cover is transparent to assist in programming one of the first timer and the second timer.

16. The apparatus of claim 11 wherein the cover and enclosure are made of an impact and water resistant material.

17. A method of remotely distributing power using a power control center apparatus, the method comprising:
receiving voltage from an input voltage line;
supplying a first line voltage from the received voltage;
supplying a second line voltage from the received voltage;
supplying a low voltage having a voltage level less than the first line voltage; and
regulating the supplying of the first line voltage and the supplying of the low voltage.

18. The method of claim 17 further comprising converting voltage from the line input voltage input to the low voltage.

19. The method of claim 17 wherein the first line voltage is supplied through a first line voltage receptacle, the second line voltage is supplied through a second line voltage receptacle, and the low voltage is supplied through a low voltage receptacle; and further comprising covering the first line voltage receptacle, the second line voltage receptacle and the low voltage receptacle.

20. The method of claim 19 further comprising mounting the first line voltage receptacle, the second line voltage receptacle and the low voltage receptacle on an enclosure.

21. A power control center apparatus configured to remotely distribute power, the apparatus comprising:
an enclosure having a plurality of sides, a top and a bottom;
a first line voltage receptacle mounted on one of the plurality of sides;
a second line voltage receptacle mounted on the one of the plurality of sides;
a low voltage receptacle mounted on the one of the plurality of sides;
an input voltage line built into the enclosure and having one end extending out from the bottom of the enclosure;
a first timer having a display and actuators and configured to control output of voltage supplied from the first line voltage, the supplied voltage corresponds to voltage supplied by the input voltage line and the display and actuators are mounted on the one of the plurality of sides and proximate to the first line voltage receptacle;
a second timer having a display and actuators and configured to control output of voltage supplied from the low voltage receptacle, the supplied voltage is less than the voltage supplied by the input voltage line and the display and actuators are mounted on the one of the plurality of sides and proximate the low voltage receptacle; and
a movable cover arranged to extend over the first line voltage receptacle, the second line voltage receptacle, the low voltage receptacle, the first timer and the second timer and attached to two sides of the plurality of sides, each of the two sides being adjacent to the one of the plurality of sides.

22. The apparatus of claim 21 further comprising a transformer mounted inside the enclosure and connected to the low voltage receptacle and configured to lower the voltage supplied by the input voltage line, the transformer having a primary winding, a secondary winding and a copper ground shield between the primary winding and the secondary winding.
